(19) United States
(12) Patent Application Publication
(10) Pub. No.: US 2026/0163431 A1
(43) Pub. Date: Jun. 11, 2026

(54) SELF-EXCITED BRUSHLESS MACHINE WITH COMPENSATED FIELD WINDINGS

(71) Applicant: The Texas A&M University System, College Station, TX (US)

(72) Inventors: Hamid A. Toliyat, College Station, TX (US); Seyed Mehdi Seyedi, College Station, TX (US); Dorsa Talebi, College Station, TX (US)

(73) Assignee: The Texas A&M University System, College Station, TX (US)

(21) Appl. No.: 19/180,072

(22) Filed: Apr. 15, 2025

Related U.S. Application Data
(63) Continuation-in-part of application No. 18/196,981, filed on May 12, 2023.
(60) Provisional application No. 63/341,549, filed on May 13, 2022.

(51) Int. Cl. H02K 3/26; H02K 1/14; H02K 1/24; H02K 3/20; H02K 11/042; H02K 19/12; H02K 19/28

(52) U.S. Cl. CPC H02K 3/26; H02K 1/148; H02K 1/24; H02K 3/20; H02K 11/042; H02K 19/12; H02K 19/28; H02K 2211/03

(57) ABSTRACT

A self-excited brushless machine with compensated field windings includes a rotor and a stator. The rotor Includes a field winding secured to the rotor, an auxiliary winding secured to the rotor, and an energy converter associated with the rotor and configured to convert current between the field winding and the auxiliary winding. The stator includes a multiphase winding. The self-excited brushless machine uses a first current to generate a first magnetomotive force on a stator of the machine, and uses a second current to generate a second magnetomotive force. A third current is induced on auxiliary windings of a rotor of the machine using the second magnetomotive force. A rotor field winding of the machine is excited with the induced currents of the auxiliary windings.

### CROSS REFERENCE TO RELATED APPLICATIONS

This patent application is a continuation-in-part of U.S. patent application Ser. No. 18/196,981, filed on May 12, 2023, which claims priority to U.S. Provisional Patent Application No. 63/341,549 filed on May 13, 2022, the entire contents of both of which are hereby expressly incorporated herein by reference.

### TECHNICAL FIELD

The present disclosure relates generally to magnetic systems, but not by way of limitation, to Self-Excited Brushless Machines (SEBM) with compensated field windings.

### BACKGROUND

This section provides background information to facilitate a better understanding of the various aspects of the disclosure. It should be understood that the statements in this section of this document are to be read in this light, and not as admissions of prior art.

Electric machines often utilize brushes and slip rings to permit current to flow from a stationary part to a rotating part. Brushes and slip rings rely on physical contact between two parts for current to pass therethrough. While brushes and slip rings can be effective, the physical contact between the parts creates wear that requires maintenance or that can lead to failures. An electric machine design that does not rely on brushes and slip rings to allow current to flow between a stationary part and a moving part would eliminate the maintenance associated with brushes and slip rings and allows for improved packaging options for the electric machine as space for the brushes and slip rings is no longer required.

### SUMMARY

This summary is provided to introduce a selection of concepts that are further described below in the Detailed Description. This summary is not intended to identify key or essential features of the claimed subject matter, nor is it to be used as an aid in limiting the scope of the claimed subject matter.

In various aspects, a three-phase stator includes a first set of windings configured as a first group multiphase, a second set of windings configured as a second group multiphase, and a third set of windings configured as a third group multiphase. The first, second, and third set of windings are configured with phase-shift.

In some aspects, the first, second, and third sets of windings are not electrically connected together and are excited separately. In some aspects, the first, second, and third sets of windings are electrically connected together.

In some aspects, each of the first, second, and third sets of windings comprises two groups of multi-phase windings to form a double three-phase stator.

In some aspects, each of the first, second, and third sets of windings comprises three groups of multi-phase windings to form a triple three-phase stator.

In various aspects, a rotor includes a plurality of field windings, a plurality of auxiliary windings, and an energy convertor configured to electrically connect the plurality of field windings to the plurality of auxiliary windings. The plurality of field windings and the plurality of auxiliary windings are concentrically arranged on the rotor.

In some aspects, the plurality of field windings are concentrically arranged inside the plurality of auxiliary windings. In some aspects, the plurality of field windings are concentrically arranged outside the plurality of auxiliary windings.

In various aspects, a self-excited brushless machine with compensated field windings includes a rotor with a plurality of field windings secured to the rotor and a plurality of auxiliary windings secured to the rotor. The plurality of field windings and the plurality of auxiliary windings are concentrically arranged on the rotor. The machine includes a three-phase stator with a first set of windings configured as a first group, a second set of windings configured as a second group, and a third set of windings configured as a third group. The first, second, and third set of windings are configured with a phase-shift.

In some aspects, the first, second, and third sets of windings are not electrically connected together and are excited separately. In some aspects, the first, second, and third sets of windings are electrically connected together.

In some aspects, each of the first, second, and third sets of windings comprises two groups of multi-phase windings to form a double three-phase stator. In some aspects. each of the first, second, and third sets of windings comprises three groups of multi-phase windings to form a triple three-phase stator.

In some aspects, the plurality of field windings are concentrically arranged inside the plurality of auxiliary windings.

In some aspects, the plurality of field windings are concentrically arranged outside the plurality of auxiliary windings.

In some aspects, the machine includes an energy converter associated with the rotor and configured to convert current between the plurality of field windings and the plurality of auxiliary windings. In some aspects, the energy converter is configured to convert AC current induced in an auxiliary winding to DC current. In some aspects, the energy converter is configured to convert a first AC current induced in an auxiliary winding to a second AC current having a different magnitude and frequency. In some aspects, the energy converter comprises an active AC/AC converter. In some aspects, the energy converter comprises a wireless transmission interface that controls switching gate commands.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 is a schematic diagram of a Self-Excited Brushless Machine according aspects of the disclosure;

FIG. 2 is a schematic diagram of a Self-Excited Brushless Machine with compensated field winding according to aspects of the disclosure;

FIG. 3 is a schematic diagram of a stator configuration with a five-phase winding according to aspects of the disclosure;

FIG. 4 is a schematic diagram of an inner rotor configuration of an SEBM according to aspects of the disclosure;

FIG. 5 is a schematic diagram of an outer rotor configuration of an SEBM according to aspects of the disclosure;

FIG. 6 is a schematic diagram of an SEBM with hybrid excitation using permanent magnets according to aspects of the disclosure;

FIG. 7 is a schematic diagram of an SEBM with a linear translator according to aspects of the disclosure;

FIG. 8 is a schematic diagram of a portion of an axial rotor for an SEBM according to aspects of the disclosure;

FIG. 9 is a schematic diagram of a stator configuration with a double three-phase winding with asymmetric phase shift between each set of three-phase winding according to aspects of the disclosure;

FIG. 10 is a schematic diagram of a stator configuration with a triple three-phase winding with asymmetric phase shift between each set of the three-phase winding according to aspects of the disclosure;

FIGS. 11A and 11B are schematic diagrams of double three-phase winding configurations according to aspects of the disclosure;

FIGS. 12A and 12B are schematic diagrams of triple three-phase winding configurations according to aspects of the disclosure;

FIGS. 13A and 13B are schematic diagrams illustrating rotor windings with auxiliary and field winding configurations, according to aspects of the disclosure;

FIGS. 14A and 14B are schematic diagrams illustrating multi-layer configurations of rotor windings with auxiliary and field windings, according aspects of the disclosure; and

FIG. 15 illustrates a schematic diagram illustrating a multi-layer stator, according to aspects of the disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described. Reference will now be made to more specific embodiments of the present disclosure and data that provides support for such embodiments. However, it should be noted that the disclosure below is for illustrative purposes only and is not intended to limit the scope of the claimed subject matter in any way.

In various aspects, the invention involves an electric machine with a multiphase stator winding that can operate without brushes and slip rings, leading to fewer maintenance requirements. The machine includes a rotor having two sets of windings, a field winding for synchronous torque and auxiliary windings for exciting the field winding. In various aspects, a multiphase winding is used to produce additional independent spatial harmonics to induce AC current on the auxiliary windings. A converter is employed to convert the induced AC currents on the auxiliary windings to AC or DC current for the field winding(s) so that flux from the rotor interacts with flux from the stator to produce torque. Since the number of poles for harmonic flux differs from fundamental flux, this feature can be used for wireless power transfer from the stator to the rotor through the auxiliary windings. In a Self-Excited Brushless Machine (SEBM), the multiphase winding is excited with two terms consisting of the fundamental and harmonic currents. Fundamental current is used to generate the main magnetomotive force (MMF) on the stator. The additional harmonic current generates another MMF used to induce currents on the auxiliary windings. By implementing a converter on the rotor, induced currents in the auxiliary windings excite the rotor field winding. So, the stator excitation controls fundamental and harmonic MMFs on the stator and indirectly controls the fundamental MMF on the rotor. Since the harmonic MMF is controlled independently by the harmonic current with a different number of poles, the frequency and amplitude of harmonic MMF can be controlled based on rotor speed. The compensation method controls the frequency of harmonic MMF to achieve the maximum torque at different rotor speeds. Especially at lower rotor speeds, induced frequency is compensated to produce the required torque without increasing the magnitude of harmonic current. U.S. Patent Publication No. 2021/0336574 describes various brushless wound field synchronous machines. The entire disclosure of U.S. Patent Publication No. 2021/0336574 is incorporated herein by reference.

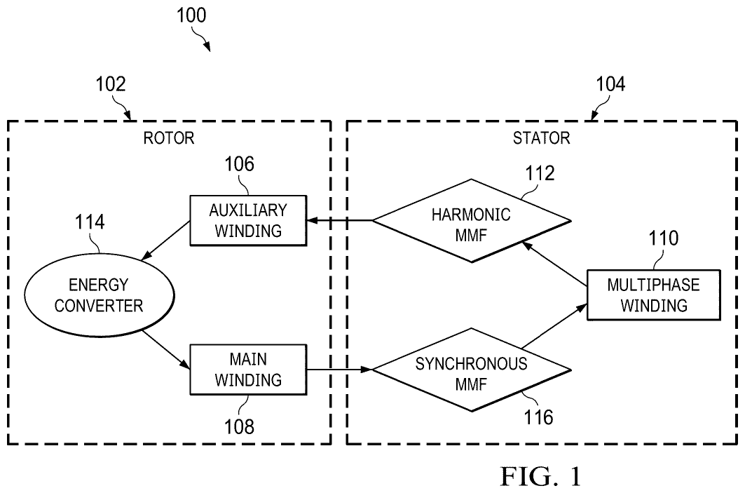

FIG. 1 illustrates a schematic structure of an SEBM 100. SEBM 100 includes a rotor 102 and a stator 104. Rotor 102 includes an auxiliary winding 106 and a main or field winding 108. Stator 104 includes a multiphase winding 110. Multiphase winding 110 creates a rotating harmonic MMF 112, which induces a current in auxiliary winding 106. The induced current in auxiliary winding 106 excites field winding 108 using an energy converter 114. Field winding 108 creates a synchronous MMF 116 that interacts with a fundamental MMF of stator 104, which ultimately produces Electromagnetic (EM) torque that may be used to rotate a shaft etc.

Using a variety of power conversions between auxiliary winding 106 and main winding 108 can create different types of SEBM 100. In a first type, an AC/DC rectifier is used for rotor power conversion and a compensated DC field is created. In a second type, an AC/AC converter is used for rotor power conversion and a compensated AC field is created. In a third type, an AC/DC rectifier with a permanent magnet is used for rotor power conversion and a hybrid DC excitation is created.

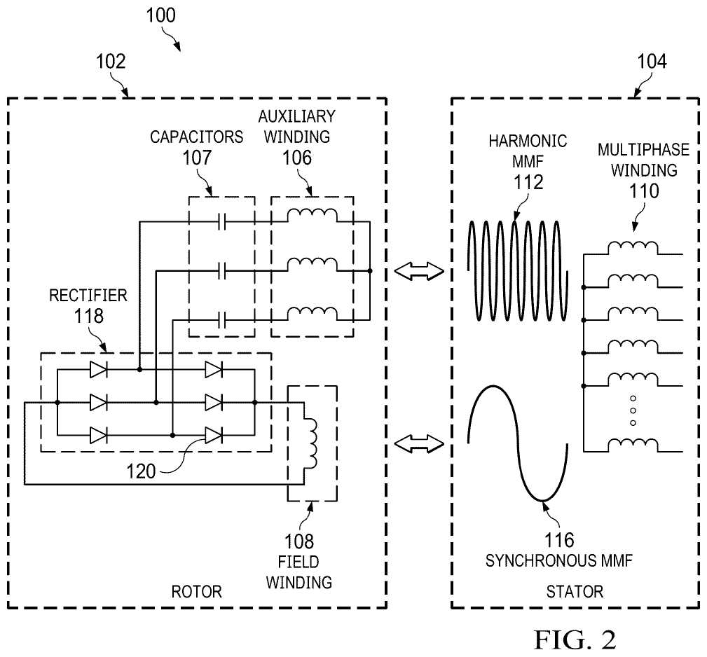

According to the first type, AC current induced in auxiliary winding 106 is converted to DC current, similar to a wound field synchronous machine. Field winding 108 carries DC current, which is used for producing fundamental rotor MMF. The rotor speed is synchronous with the fundamental MMF created by multiphase winding 110. The power converter is an AC/DC rectifier 118 and can be controlled by active switches or passive diodes 120 (e.g., see FIG. 2).

According to the second type, power transfer from auxiliary winding 106 to field winding 108 can be converted to another AC current with a different magnitude and frequency. An active AC/AC converter is used in this case, and switching gate commands are controlled through a wireless transmission interface. The fundamental MMF created by stator 104 has an asynchronous speed concerning both the harmonic MMF and the rotor speed.

According to the third type, compensated DC Field (Type 1) and Permanent Magnets (PM) are combined. This structure is a hybrid DC excited brushless machine that uses both winding of rotor 102 and PMs. The harmonic current excitation controls the field MMF; however, MMF created by PMs is constant.

FIG. 2 illustrates a schematic structure of an SEBM 100 with compensated DC field (Type 1). A unique set of multiphase winding supplied by an inverter controls both the fundamental and the harmonic currents. Harmonic MMF 112 induces a voltage on auxiliary winding 106, and the induced current is rectified through diodes 120 of rectifier 118 to supply current to field winding 108. A plurality of capacitors 107 are arranged between auxiliary winding 106 and rectifier 118. Field winding 108 creates a synchronous MMF 116 that interacts with a fundamental MMF of stator 104. The interaction between field winding 108 and the fundamental MMF produces EM torque. The induced voltage frequency on auxiliary winding 106 is compensated to a consistent value by adjusting the harmonic frequency. With a constant rate of induced frequency, the torque decreases at lower speeds because of reduced induced frequency. So, by increasing the harmonic frequency, the reduction of induced frequency is compensated. Therefore, a capacitive impedance is used, and it can minimize the leakage inductance effect and reduces the required harmonic current.

The number of phases for stator windings can be any number greater than or equal to two. The current equation for one of the phases in an SEBM can be generalized as Equation (1) below. The first term is the excitation for generating the synchronous MMF, while the second term creates the harmonic rotating MMF.

$${i}_{phase \_ k} = {I}_{mF} cos ( {ω}_{F} t - {φ}_{k} ) + {I}_{mH} cos ( {ω}_{H} t - n {φ}_{k} ) \qquad Eq . ( 1 )$$

ω_{F} and ω_{H} are the fundamental and harmonic frequencies respectively, I_{mF} and I_{mH} are the peak values of the fundamental and harmonic currents, n is the order of harmonic and φₖ is the shift angle of phase k. The order of harmonic MMF and its magnitude change based on the number of phases. In general, the number of poles for the main field and stator winding may be varied. However, the number of poles for the auxiliary windings is determined from the main field poles times the order of harmonic used for excitation. Rₚ is defined as the ratio of pole numbers of the auxiliary winding to the main winding pole numbers. Rₚ can be any odd number more than one; however, because higher-order harmonic MMF requires more harmonic current excitation, it is reasonable to use lower harmonic orders.

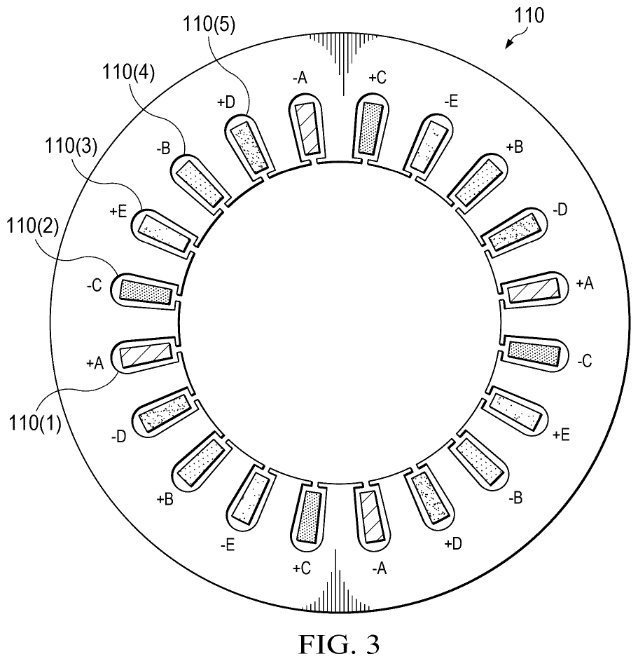

FIG. 3 shows a typical stator design (e.g., stator 104) for an SEBM with a multiphase winding 110 having five-phase stator windings 110(1)-110(5) (phases A-E). The current excitation for the five-phase stator windings can be attained from Equation (1). The winding is considered full pitch to gain maximum harmonic MMF. Short pitch winding could be used as well, but the magnitude of harmonic MMF decreases and yields a higher rate of harmonic current excitation. The stator windings could be double or single layers depending on the design and application.

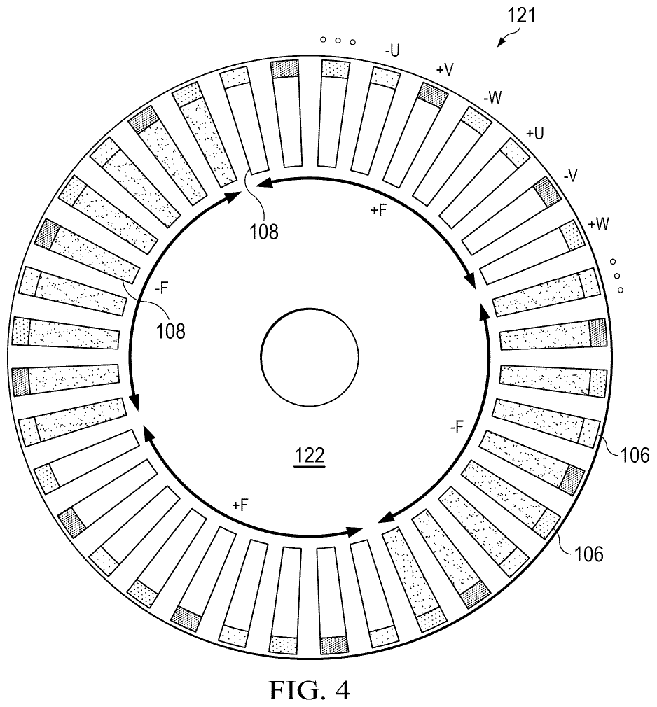

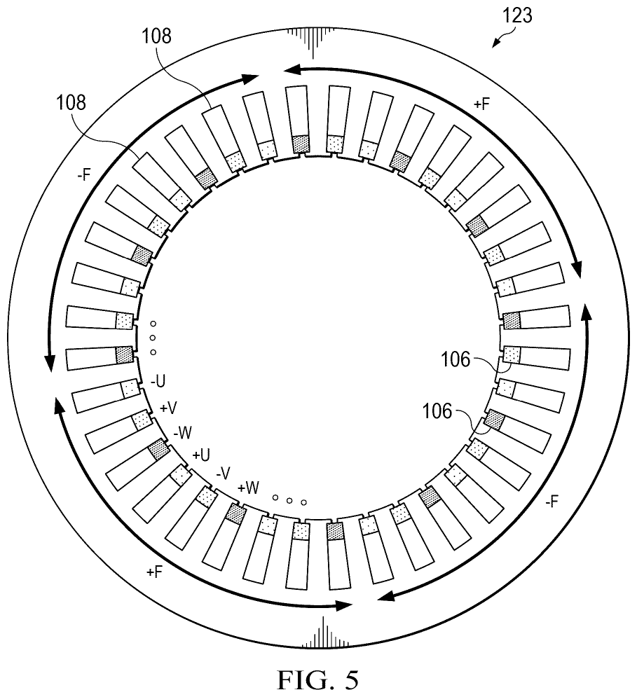

A typical rotor for use with an SEBM has at least two sets of windings. First, a single-phase winding serves as the synchronous machine field winding (e.g., field winding 108). The other is the auxiliary winding (e.g., auxiliary winding 106) utilized for power transfer from stator 104 to rotor 102. The auxiliary winding can be multiphase based on the rotor geometry; however, a single-phase can also be implemented even though the pulsating output current of the rectifier will increase sharply. FIG. 4 illustrates an exemplary inner rotor 121. Inner rotor 121 may be used as rotor 102 in various aspects. Inner rotor 121 is composed of rotor laminated steel 122, field winding 108, and auxiliary winding 106. Inner rotor 121 may include a rectifier and capacitors that are placed on inner rotor 121. In the aspect of FIG. 4, field winding 108 is a four-pole winding which is considered the synchronous excitation. In this configuration, auxiliary winding 106 is twelve poles (three times the main winding poles) and represents the wireless power transfer through the air gap and excites field winding 108. Auxiliary winding 106 has three phases to create a smooth DC current at the output of the multiphase rectifier and to help reduce torque ripple. FIG. 5 illustrates an exemplary outer rotor 123. Outer rotor 123 may be used as rotor 102 in various aspects. In the outer rotor configuration, auxiliary winding 106 has n times the number of poles of field winding 108, where n is the harmonic order used for excitation. In FIG. 5, the rotor field and auxiliary windings have four and twelve poles, respectively.

The structure of the SEBM with compensated AC field (Type 2) is similar to DC field winding (Type 1). In the case of AC excitation, the field winding should be more than one phase to create a rotating MMF. All mentioned equations, stator, and rotor structure are also valid for the compensated AC field SEBM. However, in this case, the rotor rotates in an asynchronous manner with the stator fundamental MMF speed. To control the AC/AC converter, a wireless transmission circuit may be used to command the converter switches.

SEBM can have a hybrid DC excitation combined with compensated DC field and PMs (Type 3). In Electric Vehicle (EV) applications, which usually operate in the constant power region, a high stator current is needed for field weakening in permanent magnet motors. This may cause irreversible demagnetization and decrease efficiency in high-speed operation. Further design and optimization of the motor can reduce and/or prevent the demagnetization. A combination of SEBM with PMs will provide the opportunity to reduce the harmonic excitation current at higher speeds achieving lower torques without the need for high stator currents for weakening the PM flux. This will result in a remarkably lower demagnetization risk because there is no opposite field against the PMs. The use of PMs results in a higher torque density in SEBM. Also, the control scheme of field weakening is much easier in SEBM; instead of implementing stator current to reduce the airgap field, the harmonic current is reduced. To combine the structure of the SEBM rotor with additive PMs, it is necessary to decouple the magnetic path of PMs and copper windings.

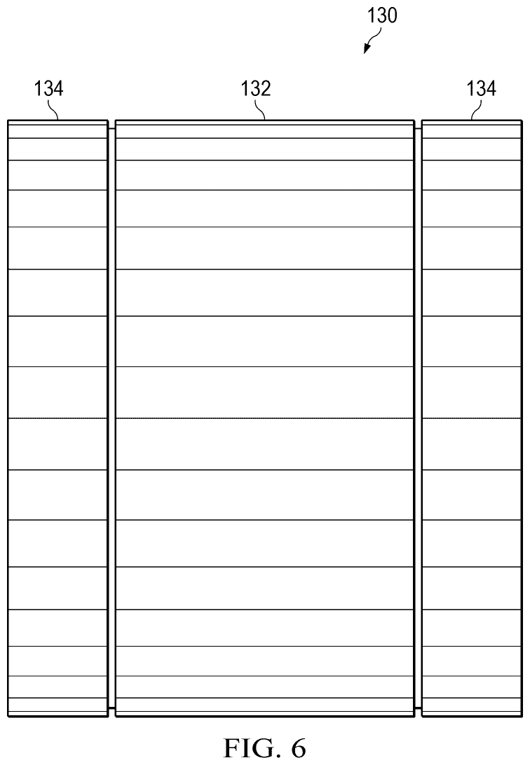

FIG. 6 illustrates an exemplary SEBM 130 with PMs 132 placed on either side of a rotor 134, with windings placed over the whole cross-section. The field winding generates MMF over the whole airgap peripheral, while PMs create MMF in the adjunct section(s). In peripheral sides, because of the existence of PMs, there is a high reluctance path that reduces flux created by the winding in those sections. So, the main MMF produced by the field winding crosses the main section (i.e., rotor 134). The volume portion of field winding and PM section depends on the power requirement of the motor (MMF produced by the field winding and PMs based on torque-speed characteristics). Also, the PMs can be placed over the whole cross-section of rotor 134 if they do not block the magnetic flux path of the copper windings.

The general current excitation for an asymmetric concept is represented by Equation (2) below:

$${i}_{phase \_ k} = {I}_{mF} cos ( {ω}_{F} t - {φ}_{k} - ( j - 1 ) {φ}_{s hift} ) + {I}_{mH} cos ( {ω}_{H} t - n {φ}_{k} - n ( j - 1 ) {φ}_{s hift} ) \qquad Eq . ( 2 )$$

ω_{F} and ω_{H} are the fundamental and harmonic frequencies, respectively, I_{mF} and I_{mH} are the peak values of fundamental and harmonic currents, n is the order of harmonic and φₖ is the shift angle of phase k. j is the number of phase sets, and k is the phase number in each one of the sets. If m is the number of phases, then 1<k<m. φ_{shift} is the shift angle between each sets of the multiphase windings. For example, for asymmetric double three-phase winding, the φ_{shift} is 30 degrees.

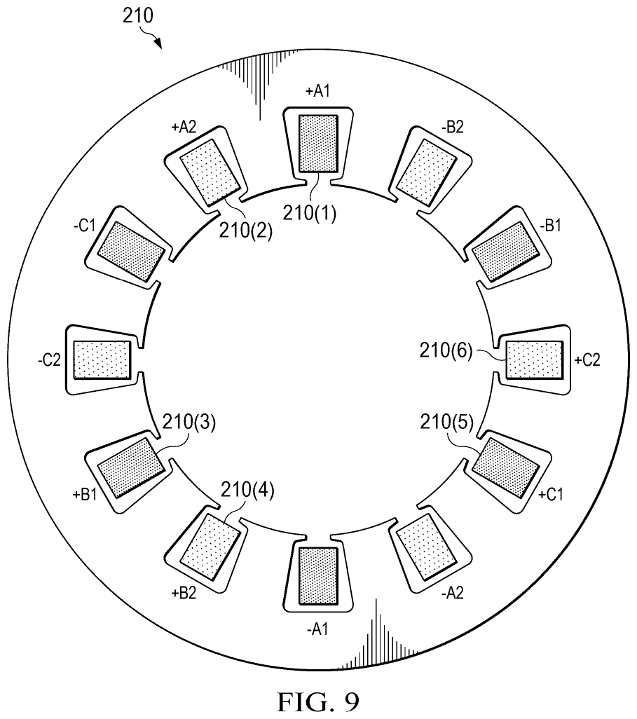

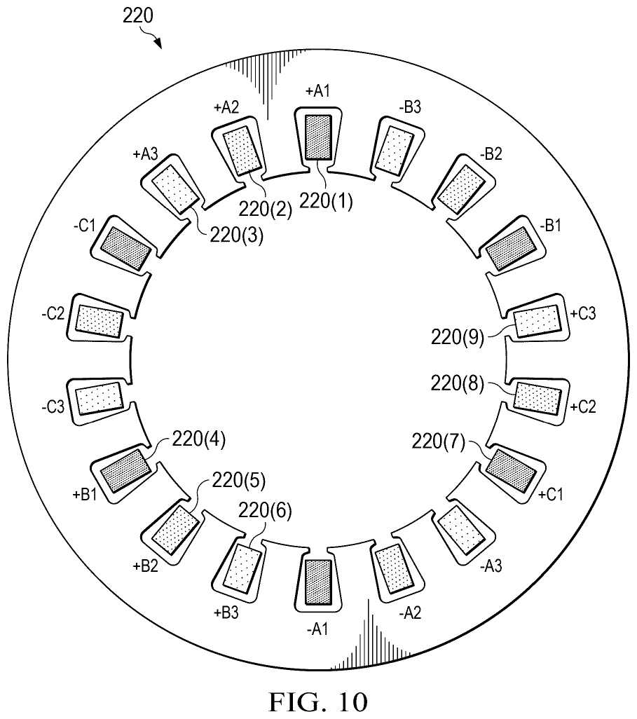

FIG. 9 is a schematic diagram of a stator configuration 210 with a double three-phase winding (e.g., +A1, −A1, +A2, −A2, +B1, −B1, +B2, −B2, +C1, −C1, +C2, −C2) with asymmetric phase shift between each set of windings 210(1), 210(2), 210(3), 210(4), 210(5), 210(6) of the three-phase winding. FIG. 10 is a schematic diagram of a stator configuration 220 with a triple three-phase winding (e.g., +A1, −A1, +A2, −A2, +A3, −A3, +B1, −B1, +B2, −B2, +B3, −B3, +C1, −C1, +C2, −C2, +C3, −C3) with asymmetric phase shift between each set of windings 220(1), 220(2), 220(3), 220(4), 220(5), 220(6), 220(7), 220(8), 220(9) of the three-phase winding. Stators 210 and 220 may be used in place of stator 104 discussed relative to FIG. 3.

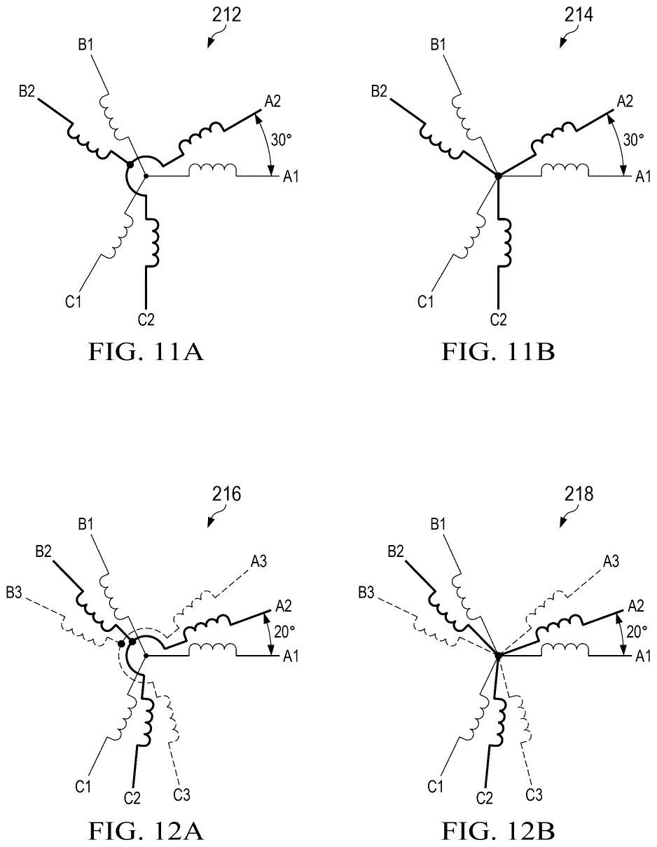

FIGS. 11A and 11B are schematic diagrams of double three-phase winding configurations that may be used with stator configuration 210 of FIG. 9. FIG. 11A illustrates a configuration 212 in which each of the two three-phase windings are not electrically connected (e.g., A1, B1, C1 are not electrically connected to A2, B2, C2). FIG. 11B illustrates a configuration 214 in which each of the two three-phase windings are electrically connected (e.g., A1, B1, C1 are electrically connected to A2, B2, C2). FIGS. 12A and 12B are schematic diagrams of triple three-phase winding configurations that may be used with stator configuration 220 of FIG. 10. FIG. 12A illustrates a configuration 216 in which each of the three three-phase windings are not electrically connected (e.g., A1, B1, C1 are not electrically connected to A2, B2, C2 and A3, B3, C3). FIG. 12B illustrates a configuration 218 in which each of the three three-phase windings are electrically connected (e.g., A1, B1, C1 are electrically connected to A2, B2, C2 and A3, B3, C3).

Configurations 210 and 220 are applicable, for example, for machines having axial or radial flux designs with wound rotor PCB rotor configurations, and will operate with single or multi-rotor designs. In operation, rotor core losses are minimized due to the absence of a core. These designs also result in efficient rotor current, as the rotor current traces can be effectively designed to eliminate the need for direct rotor cooling. These designs can also be configured to be lightweight for improved high-speed operation. The PCB rotor, being inherently lighter than a laminated rotor, reduces inertia, facilitates higher-speed operation, and enhances the power capability of the powertrain.

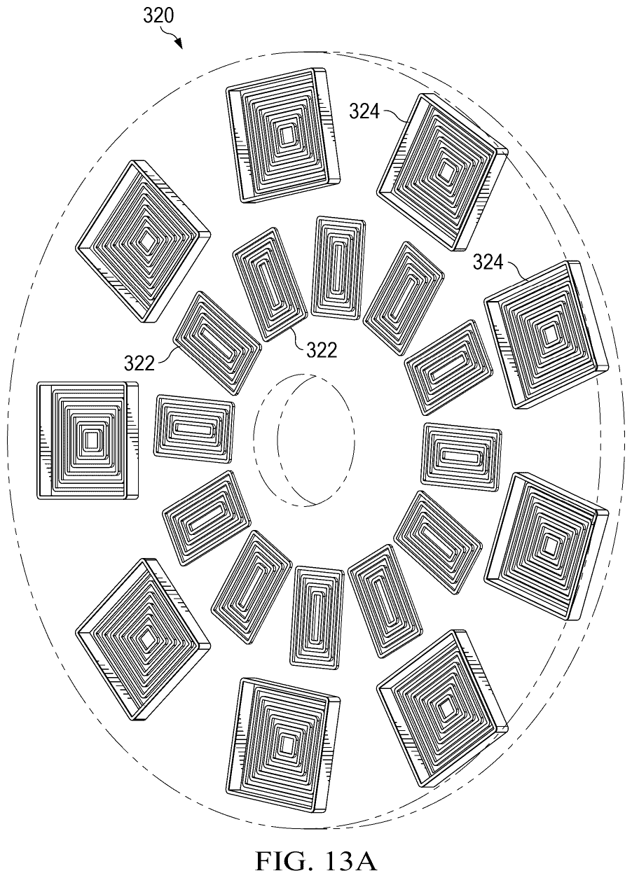

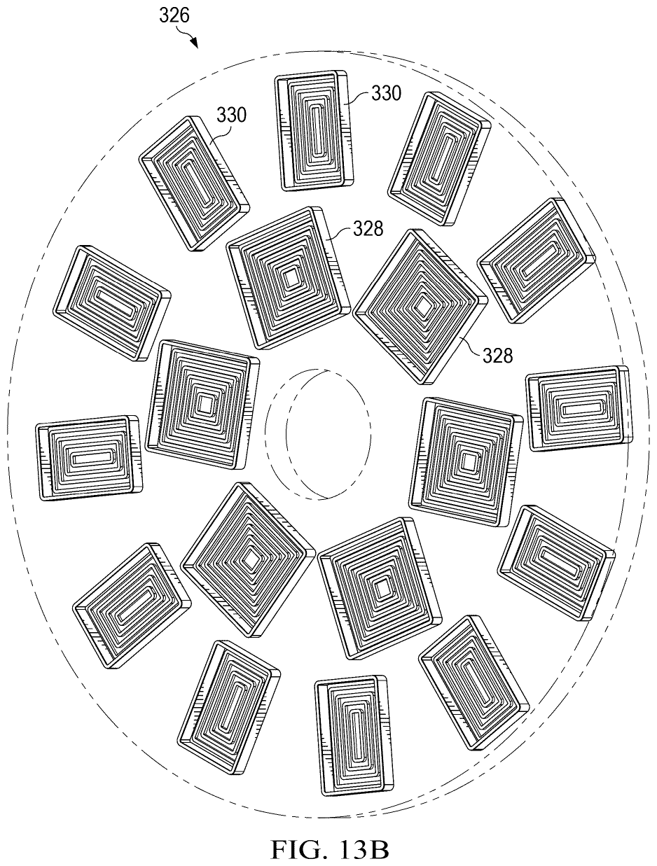

FIGS. 13A and 13B are schematic diagrams illustrating a rotor with auxiliary windings and field windings being concentrically arranged relative to one another. FIG. 13A illustrates a rotor 320 having auxiliary windings 332 concentrically arranged inside field windings 324. FIG. 13B illustrates a rotor 326 having field windings 328 concentrically arranged inside field windings 330. Rotors 320 and 326 are designed to suppress unwanted harmonics, while amplifying desired harmonics.

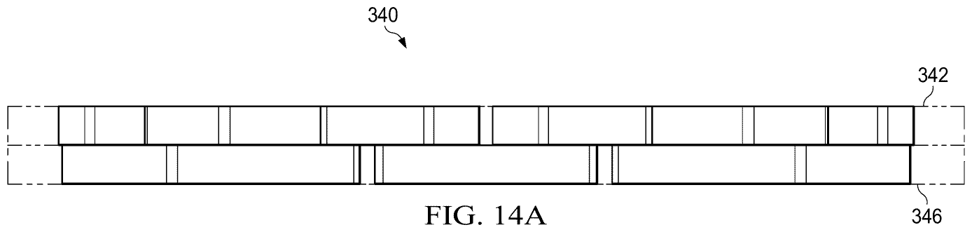

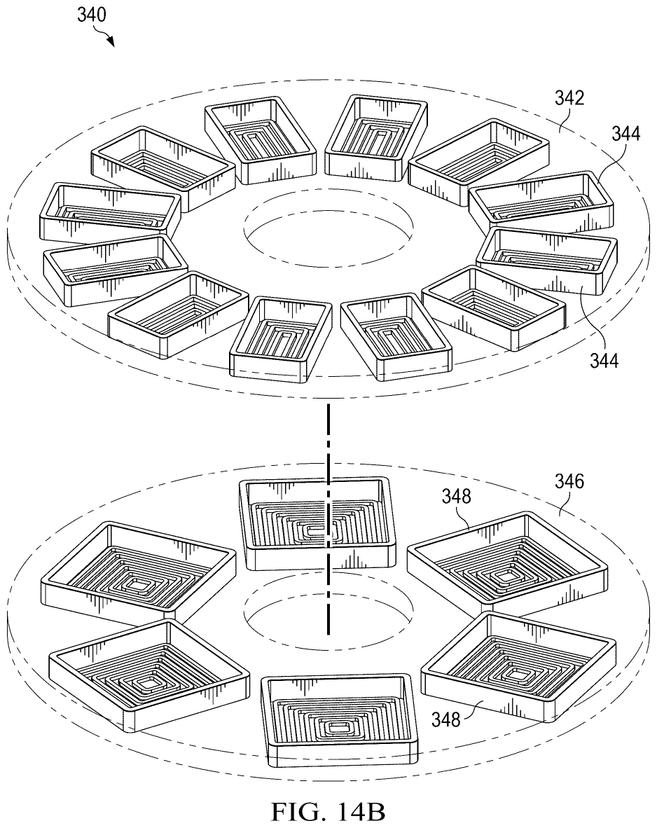

FIGS. 14A and 14B are schematic diagrams illustrating a multi-layer rotor 340, according aspects of the disclosure. FIG. 14A is a side view of multi-layer rotor 340. FIG. 14B is an exploded assembly of rotor 340. Rotor 340 includes first layer 342 comprising a plurality of field windings 344 and a second layer 346 comprising a plurality of auxiliary windings 348. Each layer 342 and 346 is a PCB that may be stacked upon one another to form rotor 340. In some aspects, an insulating layer may be disposed between layers to prevent/limit electrical interference between the layers. In some aspects, PCB layers are electrically connected via through-holes to optimize current transfer between layers. It will be appreciated that the layers may be repeated as desired.

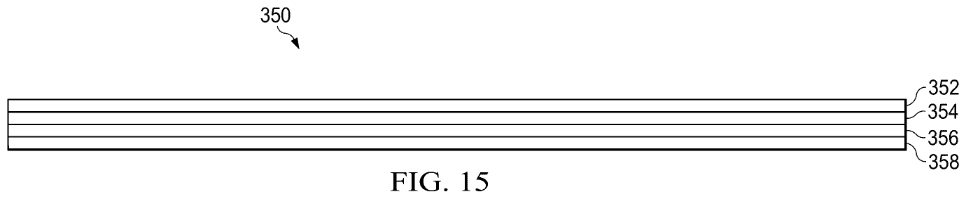

FIG. 15 illustrates a schematic diagram illustrating a multi-layer stator 350, according to aspects of the disclosure. Stator 350 comprises four layers 352, 354, 356, and 358. Each of layers 352, 354, and 356 comprises a phase of a double three-phase winding configuration, similar to the configurations illustrated in FIGS. 12A and 12B. Layer 358 is configured as a field winding.

The rotor and stator designs discussed above may be stacked and repeated as desired. For example, a machine may comprise a single rotor/stator pair or maybe configured with multiple rotor/stator pairs in a stacked configuration. Stacking rotor/stator pairs allows for a scalable design to create machines with different capabilities as needed per a particular application.

### Working Examples

An SEBM with compensated DC field and radial machine topology was evaluated, and transient responses were measured. The transient-response of field current with the rotor rotating at synchronous speed, and harmonic excitation is implemented in addition to the fundamental current. Since a voltage is induced in the auxiliary winding, building the current takes some time. Testing resulted in a field current of approximately 4 A after about 0.1 s. The three-phase auxiliary windings and the rectified field currents at the steady-state were measured. The induced voltage generated by the auxiliary winding creates a DC current of approximately 4 A using the rotor side rectifier and excites the field winding to make the rotor field MMF. Consequently, developing the rotor MMF increases the EM torque and reaches the steady-state condition. The transient response of EM torque was measured, with the steady-state torque output being approximately 30 Nm once the current had stabilized.

The harmonic MMF created by the harmonic current excitation has a different pole number than synchronous MMF. The difference between the harmonic MMF speed and the synchronous MMF speed determines the frequency of induced voltage in the auxiliary winding. On the other hand, the induced voltage frequency can be modified by changing the harmonic excitation frequency. Thus, with proposed harmonic excitation, the frequency of induced voltage can be adjusted to the synchronous speed. At low speed, the induced voltage drops because of lower induced frequency. The compensation method will determine the induced voltage frequency by adjusting the harmonic excitation frequency at different speeds. This method will help keep the torque constant without increasing the harmonic current excitation. Since the induced voltage frequency in the auxiliary winding is consistent with the compensation method, a capacitor is used to reduce the leakage effect of the winding and increase the induced voltage, as mentioned previously.

The Compensated Induced Frequency (CIF) is the induced voltage frequency in the auxiliary winding. The average torque and efficiency at different speeds for various CIFs were measured. EM torque is adjusted at a constant rate, and the efficiency is high enough during the low-speed region. Testing showed that a higher CIF value increased the torque, but resulted in a reduction in efficiency primarily as a result of the core loss effect.

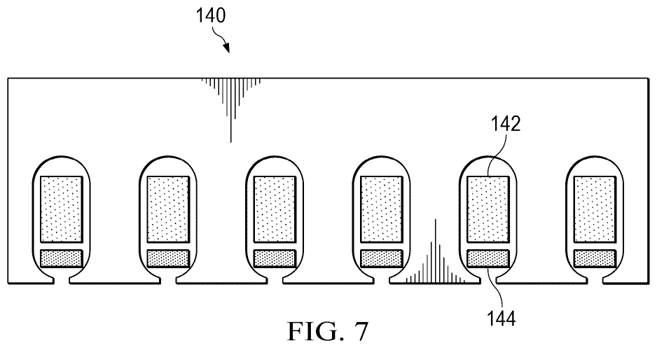

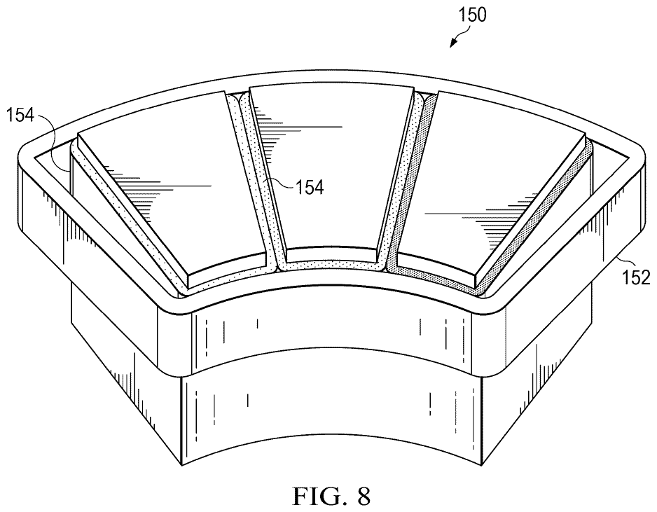

All embodiments that are Type 1, Type 2, and Type 3, having an inner rotor and outer rotor are also practical for linear and axial flux machines. FIG. 7 illustrates a linear rotor structure 140 for an SEBM. The linear rotor structure includes a plurality of field windings 142 and auxiliary windings 144 for synchronous torque production and wireless power transfer. A portion of a flux rotor structure for an SEBM is shown in FIG. 8. FIG. 8 illustrates a quarter of a flux axial rotor structure 150. Flux axial rotor structure 150 includes a field winding 152 that surrounds a plurality of auxiliary windings 154. This structure can be repeated to form an entire rotor (e.g., four times for the configuration shown). The rotor for linear and axial machines consists of a field and an auxiliary winding for synchronous operation and induction excitation.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A multigroup multiphase stator comprising:
a first set of windings configured as a first group multiphase; and
a second set of windings configured as a second group multiphase,
wherein the first and second set of windings are configured to generate multiple magnetomotive forces (MMFs) to induce current in an auxiliary winding and to generate electromagnetic torque.

2. The stator of claim 1, wherein the first and second sets of windings are not electrically connected together and are excited separately.

3. The stator of claim 1, wherein the first and second sets of windings are electrically connected together.

4. The stator of claim 1, wherein each of the first and second sets of windings comprises two groups of three-phase windings to form a double three-phase stator.

5. The stator of claim 1, wherein each of the first and second sets of windings are printed on one or more layers of a printed circuit board (PCB) that are stacked to form a multi-layer stator.

6. A rotor comprising:
a plurality of field windings;
a plurality of auxiliary windings; and
an energy convertor configured to electrically connect the plurality of field windings to the plurality of auxiliary windings,
wherein the plurality of field windings and the plurality of auxiliary windings are concentrically arranged on the rotor.

7. The rotor of claim 6, wherein the rotor comprises a plurality of printed circuit board (PCB) layers, each layer of the plurality of PCB layers comprising at least a portion of the plurality of field windings and at least a portion of the plurality of auxiliary windings.

8. The rotor of claim 7, further comprising an energy converter integrated into the plurality of PCB layers, the energy converter configured to convert AC current induced in the auxiliary windings to DC current for exciting the field windings.

9. A self-excited brushless machine with compensated field windings, the machine comprising:
a rotor comprising:
a plurality of field windings secured to the rotor; and
a plurality of auxiliary windings secured to the rotor,
wherein the plurality of field windings and the plurality of auxiliary windings are concentrically arranged on the rotor;
a multigroup multiphase stator comprising;
a first set of windings configured as a first group multiphase; and
a second set of windings configured as a second group multiphase,
wherein the first and second set of windings are configured to generate multiple magnetomotive forces (MMFs) to induce current in an auxiliary winding and to generate electromagnetic torque.

10. The machine of claim 9, wherein the first and second sets of windings are not electrically connected together and are excited separately.

11. The machine of claim 9, wherein the first and second sets of windings are electrically connected together.

12. The machine of claim 9, wherein each of the first and second sets of windings comprises two groups of three-phase windings to form a double three-phase stator.

13. The machine of claim 9, wherein each of the first and second sets of windings comprises three groups of three-phase windings to form a triple three-phase stator.

14. The machine of claim 9, wherein the rotor and the stator each comprise a plurality of printed circuit board (PCB) layers that are stacked to form a multi-layer rotor and a multi-layer stator, respectively.

15. The machine of claim 14, further comprising an energy converter integrated into the plurality of PCB layers, the energy converter configured to convert AC current induced in the auxiliary windings to DC current for exciting the field windings.

16. The machine of claim 9, further comprising an energy converter associated with the rotor and configured to convert current between the plurality of field windings and the plurality of auxiliary windings.

17. The machine of claim 16, wherein the energy converter is configured to convert AC current induced in an auxiliary winding to DC current.

18. The machine of claim 16, wherein the energy converter is configured to convert a first AC current induced in an auxiliary winding to a second AC current having a different magnitude and frequency.

19. The machine of claim 18, wherein the energy converter comprises an active AC/AC converter.

20. The machine of claim 19, wherein the energy converter comprises a wireless transmission interface that controls switching gate commands.
